(19) United States
(12) Patent Application Publication
(10) Pub. No.: US 2009/0299493 A1
(43) Pub. Date: Dec. 3, 2009

(54) SYSTEM FOR OPERATING A PLANT

(76) Inventors: Allan Bo Joergensen, Hernin (DK); Morten Kongensbjerg Larsen, Viborg (DK)

Correspondence Address: FOLEY AND LARDNER LLP;SUITE 500, 3000 K STREET NW, WASHINGTON, DC, 20007, US

(21) Appl. No.: 12/299,172

(22) PCT Filed: May 2, 2007
(86) PCT No.: PCT/DK07/00213

§ 371 Date: Jan. 12, 2009

(30) Foreign Application Priority Data
May 2, 2006 (EP) 06009024.8

(51) Int. Cl. G05B 9/02; G06F 1/26

(52) U.S. Cl. 700/21; 700/297; 700/287

(57) ABSTRACT

The invention relates to a system for operating a plant. The plant comprises a data equipment. The data equipment is provided at the location of the plant itself. The 5 data equipment comprising a data structure divided into at least a first data storage device (1,2,22) and a second data storage device (3,4,23). The at least first data storage device (1,2,22) is accessible from an external data source. The status of the first data storage device (1,2,22), during operation of the system, is determined as being trusted or un-trusted. The status of the 0 second data storage device (3,4,23), ab initio, is determined as being trusted. The external data source is connected to the first data storage device (1,2,22) and to the second data storage device (3,4,23), and the second data storage device (3,4,23) is connected to the first data storage device (1,2,22) along a data interfacing device (6,25,26).

### FIELD OF THE INVENTION

The invention relates to a system for operating a plant, preferably an energy producing unit such as a wind turbine power plant, but other plants to be monitored and controlled may also be operated by the system according to the invention. The invention also relates to a method for operating the plant by utilising the system according to the invention.

### BACKGROUND OF THE INVENTION

Plants to be monitored and operated are operated either at the plant itself or from a central monitoring and controlling site. Communication between the plant to be operated and the central site is performed along dedicated communication networks ensuring safe, reliable and constant communication between the plant and the central site. Accordingly, the communication takes place by the use of strictly non-public communication networks.

US 2003/0208448 discloses a data brokering system for semiconductor wafer data comprising: a fabricator (FAB) having at least one automated semiconductor wafer manufacturing tool; a plurality of OEMs, coupled to the FAB via a secure service net; means for providing data about a semiconductor wafer manufactured by the tool to one of the OEMs without revealing information about the tool; and means for collecting fees based on characteristics of the provided data. The problem stated by US 2003/0208448 is that what is needed then is an improved method of sharing data remotely between OEMs and IC manufacturers, and other third-parties, that maintains data security for both the OEM and the IC manufacturer and that allows remote servicing of the tools. According to an exemplary embodiment of US2003/0204884, an application server is coupled to an HTTP server, which can provide access to an external network such as the Internet, through a third firewall. A client located, for example, at an original equipment manufacturer (OEM) connects through the HTTP server to access the tool and services provided by the application server 412. Firewalls of the US-invention can be configured to allow only authorized connections to their networks based on security policies set by the ICM. Thus, the system according to US2003/0204884 is an authorisation system. The data storage device is not a data storage device the status of which during operation is being determined as being trusted or un-trusted. Only the users accessing the data storage device is during operation being determined as being authorised or non-authorised. The object of the data brokering system is to provide an improved method of sharing data remotely between OEMs and manufacturers, and other third-parties that maintains data security for both the OEM and the manufacturer and that allows remote servicing of the tools.

The object is not to safeguard the manufacturer (the FAB site) towards invalid data. The object is to divide access to the manufacturer (at the FAB site) between different OEMs.

The FAB site is housing one or more automated semiconductor manufacturing tools, which are each coupled to a tool console server. The Tool Console Servers constitute data equipment provided at the location of the plant. Data from a Client to the Tool Console Servers has to pass an HTTP Server, an Application Server, a Toll Gateways Server and a plurality of firewalls. There is no authentication at the FAB site, i.e. at the location of the plant, where the data equipment is provided. Thus, once data has entered the FAB site, all data equipment is accessible. Thus, invalid data from an external data source, and possibly passing or circumventing the plurality of firewalls, will have unlimited access to the data equipment at the location of the plant.

U.S. Pat. No. 6,079,016 discloses a computer having multi booting function with more than two boot-ROMs. The boot-ROMs comprise a flash PAM, and have the same address space in the computer system. Preferably, the first boot-ROM is provided with a general boot program, and the second boot-ROM with detailed diagnostic program. Alternatively, the first boot-ROM is provided with a conventional boot program, and the second boot-ROM with reprogrammed or updated boot programs. U.S. Pat. No. 6,079,016 discloses as one of the problems to be solved is unstable hardware condition or programming error in the flash ROM preventing the operating system from loading into the computer system, and executing another diagnostic program in the operating system is not possible.

U.S. Pat. No. 6,079,016 discloses as one of the problems to be solved is unstable hardware condition or programming error in the flash ROM preventing the operating system from loading into the computer system, and executing another diagnostic program in the operating system is not possible. The object of the multi-booting function according to U.S. Pat. No. 6,079,016 is to provide a computer system with multi booting function which can selectively perform full diagnostics of the computer system without using a diagnostic program in an operating system. The object is also to provide a computer system with multi booting function that ensures safe operation of reprogrammed or updated booting programs stored in a flash ROM.

The object is not to safeguard the computer towards invalid data from an external network. The object is to ensure that the computer system will always boot. The computer system is not connected to any external data source. U.S. Pat. No. 6,079,016 does not disclose a safety guarding towards data from an external data source. Therefore, invalid data from a possible external data source will have unlimited access to the booting function of the computer system. A HTTP server is disclosed, said HTTP server being located in non-demilitarized zone, said HTTP server thus not being located at the site of the eCentre Application server and/or of the Tool Gateway server also disclosed, said other servers located in demilitarized zones

U.S. Pat. No. 5,374,231 discloses an automatically operable manufacturing and machining plant. It comprises a plurality of machining cells, a management system for the workpieces including storage appliances for storing the workpieces, transporting appliances for transporting the workpieces and handling appliances for manipulating the workpieces, and a data handling and exchange system for controlling the operations of the manufacturing and machining plant.

The data handling and exchange system comprises a first external data handling and exchange network with a central data processing unit for the exchange of operation control data between the central data processing unit and the machining cells and for the exchange of transporting control data between the central processing unit and the transporting appliances. Further, there is provided a second internal data handling and exchange network for the exchange of data between the storage appliances, the transporting appliances and the handling appliances. The data contained in the memory modules are processed by the second internal data handling and exchange network.

According to U.S. Pat. No. 5,374,231, one object is to provide an automatically operable manufacturing and machining plant which has an improved system for the identification of the workpieces and the handling of data required for the manufacturing or machining of a certain workpiece. The object is not to secure the data handling system towards possible invalid data from an external data source. Therefore, invalid data from a possible external data source will have unlimited access to the data exchange system of the manufacturing and machining plant.

Further, according to U.S. Pat. No. 5,374,231 there is provided a second internal data handling and exchange network for exchanging data between the storage appliances, the transporting appliances and the handling appliances. The only safety aspect discussed in the disclosure is safety against inadvertent confusions of the relation of the data and the workpieces and tools and against possible disordered storage of the workpieces and tools.

Further, U.S. Pat. No. 5,374,231 discloses that an important prerequisite for a troublefree operation of the manufacturing and machining plant is the safety of the data exchange. Considering the often rough conditions in the region of the machining cells with the disturbing influences of heat, oil, metal chips and cooling fluids, it is advantageous to use a system for the data exchange with touchless operation, preferably a wireless carrier frequency data exchange system.

### SUMMARY OF THE INVENTION

The object of the invention is to provide a system for operating a plant and which system is capable of communicating along more public networks possibly having no data safety or at least along communication networks perhaps having a reduced safety, but maintaining, at the location of the plant, the same safe, reliable and constant communication and operation as is present with safe communication networks of today.

This object may be obtained by a system for operating a plant according to a common aspect of the invention,
said system comprising a data equipment provided at the location of the plant, said data equipment comprising a data structure divided into at least a first data storage device, a second data storage device and a data interfacing device, at least said first data storage device being accessible from an external data source being external to the system,
said system comprising data equipment provided at the location of the plant, said data equipment comprising a data structure divided into at least a first data storage device, a second data storage device and a data interfacing device, at least said first data storage device being accessible from an external data source being external to said system,
said first data storage device being a data storage device the status of which during operation being determined as being trusted or un-trusted,
said second data storage device being a data storage device the status of which ab initio being determined as being trusted, and
said first data storage device being a data storage device the status of which during operation being determined as being trusted or un-trusted,
said second data storage device being a data storage device the status of which ab initio being determined as being trusted, and
the external data source being connected to said first data storage device and to said second data storage device
the second data storage device being connected to said first data storage device along a data interfacing device
   characterised in
said data interfacing device comprising a control unit, a first status controller and a second status controller,
said first status controller intended for controlling the transmission of data from the external data source to the first data storage device, and said second status controller intended for controlling the transmission of data from the external data source to the second data storage device, and
said switching unit intended for controlling for validity, at the site of the plant, the data of an external network, said external network comprising a data network and a service network, and
said switching unit intended for transmitting the data to an internal network in case the data is determined by the switching unit to be valid data in respect of operating the plant, said internal network comprising a data network and a service network, and
the content of said data being stored at the second data storage device at the site of the plant, provided the data have been transmitted.

A system comprising an un-trusted data storage device and also comprising a trusted data storage device, and where an interfacing device controls communication between the un-trusted data storage device and the trusted data storage device makes it possible to operate a plant even in circumstances where the communication network to the plant is infected or in any other manner is subjected to un-authorised data being deliberately or accidentally sent to the plant. Such data may impede or alter the operation of the plant, leading to damageable faults of the supply of electrical energy or supply of other performance from the plant.

According to a first aspect of the invention, a system for operating a plant is provided,
said system comprising a data equipment provided at the location of the plant, said data equipment comprising a data network divided into an external network and a internal network, at least said external network being accessible from an external data source,
said external network being an un-trusted data network and said internal network being a trusted data network, and said external network being connected to the internal network along a control unit and a switching unit such as example a combination of a VLAN-aware switch and a firewall, possible a VLAN-aware firewall,
said external network and said internal network both comprising a data network for transmitting data within the plant, and a service network for servicing the plant by receiving data from and/or transmitting data to the plant,
said system comprising a switching unit for controlling for validity, at the site of the plant, the transmission of data from the external network to the internal network, in case the data is determined by the switching unit (6) to be valid data in respect of operating the plant,
said switching unit being provided at an interface between the external network and the internal network, and
said system further comprising a data filtering system for controlling the transmission of data from the internal data network to the internal service network,
said data filtering system being provided with means for monitoring data being transmitted from the internal service network to the internal data network, and
said data filtering system also being provided with means for deciding whether the data being transmitted from the internal service network to the internal data network are data being valid or non-valid for operating the plant,
said data filtering system being provided in a parallel network connection at an interface between the switching unit and the internal data network and the internal service network.

Providing an external network and an internal network and transmitting data from the external network to the internal network along a switching unit ensures that data may be controlled at the external network for validity before being transmitted to the internal network. The network is a virtual local access network (VLAN) operating at the site of the plant and not operating remotely from the plant.

Accordingly, even unauthorised data being transmitted to the external network at a location nearby the plant will be characterised as data of the external network along the entire communication network up to and at the site of the plant, where the switching unit is installed.

It is only at the site of the plant that the switching unit controls the data of the external network and transmits the data to the internal network in case the data is determined by the switching unit to be valid data in respect of operating the plant.

According to a second aspect of the invention, a system for operating a plant is provided
said plant comprising data equipment provided at the location of the plant, said data equipment comprising a data structure divided into at least a first data storage device and a second data storage device, both of said first data storage device and said second data storage device being accessible from an external data source,
said first data storage device being connected to a first status controller, and said second data storage device being connected to a second status controller,
said first data storage device and said second data storage device both having a write-protected state and a write-enabled state,
said first status controller intended for controlling the transmission of data from the external data source to the first data storage device, and said second status controller intended for controlling the transmission of data from the external data source to the second data storage device, and
a control unit being intended for controlling the operating of the status controllers by transmitting signals to either one or both of the status controllers, said signals from the control unit (24) intended for putting either one or both of the data storage devices in one of two possible statuses,
either said signal being intended for telling one of the status controllers to put the corresponding data storage device in a write-enabled status for allowing data to be transmitted from the external data source to the corresponding data storage device,
or said signal being intended for telling one of the status controllers to put the corresponding data storage device in a write-protected status for denying data to be copied from the external network to the corresponding data storage device.

Providing a first data storage device and an second data storage device and transmitting data to the first data storage device and to the second data storage device along a first status controller and along a second status controller, respectively, ensures the following advantage: Data may be transmitted to the first data storage device or to the second data storage device, and if the data are not valid, the date storage device, which the data has been transmitted to, i.e. either the first data storage device or the second data storage device is write-protected. The data of the other data storage device not having received the non-valid data is then the data storage device used as for at least partly operating the plant, such as performing a booting of one or more main operating systems of the plant.

The first data storage device as well as the second data storage device may be so-called flash memory data storage devices operating at the site of the plant and not operating remotely from the plant.

Accordingly, even unauthorised data being transmitted to the data storage devices at a location nearby the plant, and possibly being data of an external data source along the entire communication system up to and at the site of the plant, where the status controllers are installed.

It is only at the site of the plant that the content of the data having been transmitted and stored on one at the data storage devices are monitored and controlled. However, if the data is determined as being non-valid, the data storage device onto which the data are stored are write-protected, and the data are denied accessing to the main operating system of the plant. The data storage device may subsequently have the data erased or in other manner having the data displaced or replaced so that the data cannot harm the main operating system of the plant. In the meantime, the other data storage device is used for at least partly operating the system.

The notation ‘at the site of the plant’ is to be construed as being the physical placement of the site, however, when encompassing the communication network or encompassing the data storage device, the physical location may be construed as a wider physical extension, i.e. the location of the plant as such together with the location of any internal communication network perhaps extending beyond the location of the plant as such. As example, the site of the plant may be one or more energy producing plants such as wind turbines being part of a wind turbine park.

Thus, the site of the plant may be only one energy producing unit such as only one wind turbine of a wind turbine park, the site of plant may be a limited plurality of energy producing plants such as a limited plurality of wind turbines of an entire plurality of wind turbines in a wind turbine park, or the site of the plant may all the energy producing units such as all the wind turbines of the entire plurality of wind turbines in a wind turbine park.

### BRIEF DESCRIPTION OF THE DRAWING

The invention will hereafter be described with reference to the drawing, where

FIG. 1 is a schematic view of a first aspect of the invention, and

FIG. 2 is a schematic view of a second aspect of the invention.

### DETAILED DESCRIPTION OF THE INVENTION

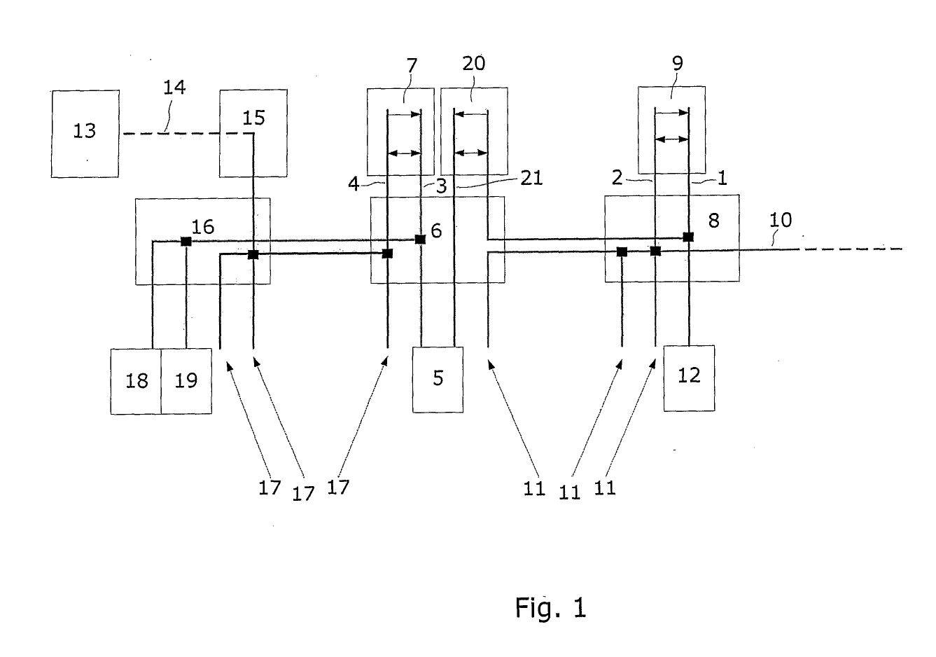

FIG. 1 is a sketch of a system incorporating a VLAN (Virtual Local Access Network) to be used for controlling an energy producing plant such as a wind turbine plant. The VLAN includes an external network 1,2 and an internal network 3,4. The external network 1,2 comprises a data network 1 and a service network 2. Also the internal network comprises a data network 3 and a service network 4.

The external data network 1 and the internal data network 2 are communicating along a control unit 5. However, the communication between the external data network 1 and the internal data network 3 is controlled by a switch 6. Also, communication between the external service network 2 and the internal service network 4 is controlled by the switch 6.

Coupled in parallel to the switch 6, between the internal data network 3 and the internal service network 4 is a first data filtering device 7 such as a router and/or a firewall. The first data filtering device 7 controls the operation of the switch 6 by allowing or denying data to be transmitted from the internal service network 4 to the internal data network 3.

The first data filtering device 7 is provided with means for monitoring data being transmitted from the internal service network 4 to the internal data network 3, and the first data filtering device 7 is also provided with means for deciding whether the data being transmitted from the internal service network 4 to the internal data network 3 are data being valid or non-valid for operating the plant.

Thus, the first data filtering device 7 is capable of allowing or denying access of data from the internal service network 4 to the internal data network 3 depending on the validity of the data as decided by the first data filtering device 7. The decision is made based on empirical data stored in the first data filtering device 7.

Furthermore, coupled in parallel to the switch 6, between the external data network 1 and the control unit 5 is a second data filtering device 20 such as a router and/or a firewall. The second data filtering device 20 controls communication to the control unit 5 along a dedicated communication line 21 by allowing or denying data to be transmitted from the external data network 1 along the dedicated communication line 21 to the control unit 5.

The second data filtering device 20 is provided with means for monitoring data being transmitted from the external data network 1 to the control unit 5 and the second data filtering device 20 is also provided with means for deciding whether the data being transmitted from the external data network 1 to the control unit 5 are data being valid or non-valid for operating the plant or at least for operating the control unit 5.

Thus, the second data filtering device 20 is capable of allowing or denying access of data from the external data network 1 to the control unit 5 depending on the validity of the data as decided by the second data filtering device 20. The decision is made based on empirical data stored in the second data filtering device 20.

The external service network 2 may be accessed from a remote external data source (not shown) along a data communication system 10 such as a VPN (Virtual Personal Network), possibly transmitting both valid data and non-valid data, in relation to operating the plant, from the remote external data source. The external service network 2 may alternatively and/or additionally be accessed from external service points 11.

Data being transmitted from the external data source and/or from the external service points are passed along the external data network 1 and to a switch 9 for controlling data being transmitted from the external data network 1 to the external service network 2.

Coupled in parallel to the switch 8, between the external data network 1 and the external service network 2 is a data filtering device 9 such as a router and/or a firewall. The data filtering device 9 controls the operation of the switch 8 by allowing or denying data to be transmitted from the external service network 2 to the external data network 1.

The data filtering device 9 is provided with means for monitoring data being transmitted from the external service network 2 to the external data network 1, and the data filtering device is also provided with means for deciding whether the data being transmitted from the external service network 2 to the external data network 1 are data being valid or non-valid for operating the plant.

Thus, the data filtering device 9 is capable of allowing or denying access of data from the external service network 2 to the external data network 1 depending on the validity of the data as decided by the data filtering device 9. The decision is made based on empirical data stored in the data filtering device 9.

Subsequent to the data filtering device 9 possibly having allowed data to access the external data network 1, the data may be transmitted to the switch 6 for utilising the date in the internal data network for operating the plant. The data may be transmitted through the control unit 5 and/or past the control unit 5, depending on whether the control unit 5 is in need for handling the data or not.

Alternatively or additionally, the data may be transmitted to a data storage and handling unit 12 such as a server for storing the data for possible subsequent use of the rata, or for handling the data for immediate use in the external data network 1, before or at the same time as transmitting the data to the internal data network 3 through the switch 6.

Alternatively or additionally to accessing the internal service network from the external network 1,2 through the switch 6, the internal service network 4 may be accessed from a local external data source 13 such as a PDA (Portable Digital Assistant) along a data communication system 14, possibly transmitting both valid data and non-valid data, in relation to operating the plant, from the local external data source 13. The data being transmitted along the local communication system 14 enters the plant and the internal service network 4 at an access point 15. The internal service network 4 may alternatively and/or additionally be accessed from internal service points 16.

Subsequent to the data filtering device 7 possibly having allowed data to access the internal data network 3, the data may be transmitted to the switch 6 and further on to the switch 16 for utilising the date in the internal data network for operating the plant. The data are transmitted to data storage and/or handling units 18,19 within the plant, such as a local plant control center or a data acquisition system, for storing the data for possible subsequent use of the data, or for handling the data for immediate use in the internal data network 1.

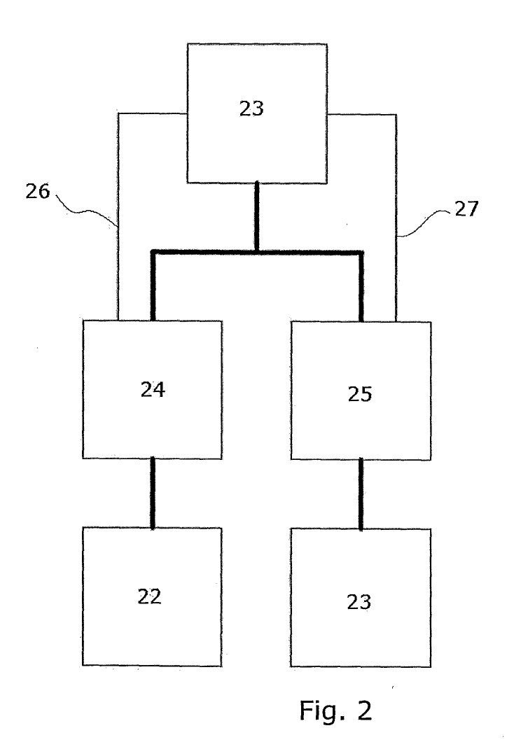

FIG. 2 is a sketch of a system incorporating two data storage devices 22,23 coupled in parallel to be used for controlling an energy producing plant such as a wind turbine plant. The data storage devices 22,23 comprise a first data storage device 22 and a second data storage device 23. The first data storage device 22 and the second data storage device 23 are communicating with an external data source (not shown) along a control unit 5. A communication status between the first data storage device 22 and the external data source, and a communication status between the second data storage device 23 and the external data source is controlled by the control unit 5. The control unit 5 controls the operation of a first status controller 24 and a second status controller 25, respectively.

The first status controller 24 and the second status controller 25 are positioned at an interface between the data storage devices 22,23 and the control unit 5 communicating with the external data source (not shown). The control unit 5 is capable of controlling the status controllers 24,25 in order of allowing or denying access of data from the external data source to the first data storage device 22 or to the second data storage device 23.

The control unit 5 controls the status controllers 24,25 by transmitting along signalling lines 26,27 to the status controllers 24,25 signals regarding the operation of the status controllers 24,25. The signals being transmitted depend on information being received from the external data source.

If data of the external data source is intended for, or at least is tried, being transmitted to either one or both of the data storage devices 22,23, the data has to pass the control unit 5 and either one or both of the status controllers 24,25. The control unit 5 transmits to either one or both of the status controllers 24,25 a signal of allowing access of the data to either one or both of the data storage devices 22,23. Preferably, the data are only transmitted to only one of the data storage devices 22,23 as will be explained in detail later in conjunction with describing the operation of the system.

The status controllers 24,25 ensure that the status of the data storage devices are maintained or changed to write-enabled status, when data are to be transmitted to either one or both of the data storage devices 22,23, depending on whether either one or both of the data storage devices 22,23 already are in a write-enabled status, or whether either one or both of the data storage devices are in a write-protected status.

The main purpose of the two data storage devices 22,23 is the following: When the plant being operated needs to be updated with new data or needs to be updated with revised data for operating the plant, data are transmitted to the plant from the external data source along an external data network. It is important for operating the plant that the data being employed for operating the plant are valid and non-infected, i.e. that there is no risk of the data impeding the operation of the plant or the data operating the plant wrongly, such as when data containing vira, worms or other infections of data are transmitted to data operating systems of the plant.

The data are to be transmitted to a main operating system not shown in the figure. However, before the data are transmitted to the main operating system, the data are controlled in the control system shown in the figure. The data from the external data source enters the control system along an external data network. The control unit 5 only controls whereto the data are to be transmitted, either to the first data storage device 22 or to the second data storage device 23. The control unit does not control the validity of the data.

A signal is transmitted from the control unit 5 to perhaps the first status controller 24 telling the status controller to put the first data storage device 22 in a write-enabled status. The first data storage device 22 in this context functions as a dormant data storage device, and the second data storage device 23 functions as a data storage device for at least partly operating the system. Either the first data storage device 22 is already in the write-enabled status or the status controller changes the status of the first data storage device 22 from a write-protected status to the write-enabled status.

When doing so, the parallel second data storage device 23 is preferably in a write-protected status so that the data cannot be transmitted to the both the first data storage device 22 and to the second data storage device 23 at the same time. Thereby, data already stored on the second data storage device 23 is maintained un-altered, although new data or revised data are being transmitted from the external data source to the control unit 5.

When the new data or the revised data has been transmitted to and has been stored in the first data storage device 22, the control unit 5 signals to the first status controller 22 to put the first data storage device 22 in a write-protected status. Thus, subsequent to putting the first data storage device 22 in the write-protected status, any data from the external data source cannot be transmitted to the first data storage device 22 and neither to the second data storage device 23. The data having been transmitted to and stored in the first data storage device 22 is then controlled for validity in respect of operating the plant. The means for controlling may be any suitable means such as by sectorized MD5 checksums.

If the data is determined as being valid in respect of operating the system, the control system sets the first data storage device 22 as the boot device for the plant, and the first data storage device 22 may reboot if desired. After a reboot, the data of the first data storage device 22 will be the data used for at least partly operating the plant.

If the data is determined as being non-valid in respect of operating the system, the control system sets the first data storage device 22 as the device not to boot the plant, and the second data storage device 23 is used for booting the plant. As an alternative or as a supplement, if booting from the first data storage device 22 fails a number of times, perhaps three times, the second data storage device 23 will be the device used for booting the plant.

In both cases, either a direct determination of non-valid data having been stored on the first data storage device, or booting from the first data storage device failing, is or may be an indication of infected or otherwise possibly harmful data in respect of operating the plant having entered part of the operating system of the plant, however a part of the operating system dedicated to storing such possibly harmful data before the data enters the main operating system of the plant.

Detection of faulty booting from the first data storage device 22 may not only lead to booting from the second data storage device 23 instead. A message is posted in the operating system of the plant, that the first data storage device 22 is operating in a faulty manner, and that perhaps data stored at the first data storage device 22, i.e. the software stored on the first data storage device 22, are non-valid data in respect of operating the plant, or that perhaps the first data storage device 22 in itself, i.e. the hardware itself, is damaged.

1-22. (canceled)

23. A system for operating a plant,
said system comprising data equipment provided at the location of the plant, said data equipment comprising a data structure divided into at least a first data storage device (22), a second data storage device (23) and a data interfacing device (6,24,25), at least said first data storage device (22) being accessible from an external data source being external to said system,
said first data storage device (22) being a data storage device the status of which during operation being determined as being trusted or un-trusted,
said second data storage device (23) being a data storage device the status of which ab initio being determined as being trusted, and
the external data source being connected to said first data storage device (22) and to said second data storage device (23)
the second data storage device (23) being connected to said first data storage device (22) along a data interfacing device (6,24,25),
characterised in
said data interfacing device (6,24,25) comprising a control unit (5), a first status controller (24) and a second status controller (25),
said first status controller (24) intended for controlling the transmission of data from the external data source to the first data storage device (22), and said second status controller (25) intended for controlling the transmission of data from the external data source to the second data storage device (23), and
a switching unit (6) intended for controlling for validity, at the site of the plant, the data of an external network, said external network comprising a data network (1) and a service network (2),
and said switching unit (6) intended for transmitting the data to an internal network in case the data is determined by the switching unit (6) to be valid data in respect of operating the plant, said internal network comprising a data network (3) and a service network (4), and
the content of said data being stored at the second data storage (23) device at the site of the plant, provided the data have been transmitted.

24. A system according to claim 23,
said system comprising data equipment provided at the location of the plant, said data equipment comprising a data network divided into an external network (1,2) and a internal network (3,4), at least said external network (1,2) being accessible from an external data source,
said external network (1,2) being an un-trusted data network and said internal network (3,4) being a trusted data network, and said external network (1,2) being connected to the internal network (3,4) along a control unit (5) and a switching unit (6) such as example a combination of a VLAN-aware switch and a firewall, possible a VLAN-aware firewall,
said external network (1,2) and said internal network (3,4) both comprising a data network (1,3) for transmitting data within the plant, and a service network (2,4) for servicing the plant by receiving data from and/or transmitting data to the plant,
said system comprising a switching unit (6) for controlling for validity, at the site of the plant, the transmission of data from the external network (1,2) to the internal network (3,4), in case the data is determined by the switching unit (6) to be valid data in respect of operating the plant,
said switching unit (6) being provided at an interface between the external network (1,2) and the internal network (3,4), and
said system further comprising a data filtering system (7) for controlling the transmission of data from the internal data network (3) to the internal service network (4),
said data filtering system (7) being provided with means for monitoring data being transmitted from the internal service network (4) to the internal data network (3), and
said data filtering system (7) also being provided with means for deciding whether the data being transmitted from the internal service network (4) to the internal data network (3) are data being valid or non-valid for operating the plant,
said data filtering system (7) being provided in a parallel network connection at an interface between the switching unit (6) and the internal data network (3) and the internal service network (4).

25. A system according to claim 24, where the external data network (1) is intended for acquiring data from a plurality of plants within a collection of plants, and where the internal data network (3) is intended for acquiring data from at least one plant, possibly from only one plant.

26. A system according to claim 25, where the collection of plants is a plurality of energy producing units, where the plurality constitutes the collection and the individual energy producing units constitute individual plants, and where the external network (1,2) constitutes a data network for a plurality of energy producing units, and where the internal network (3,4) constitutes a data network for the at least one energy producing unit, possibly for only one energy producing unit.

27. A system according to claim 26, where the collection of plants is a park of wind turbines, where the park constitutes the collection and the individual wind turbines constitute individual plants, and where the external network (1,2) constitutes a data network for a plurality of wind turbines, and where the internal network (3,4) constitutes a data network for the at least one wind turbine, possibly for only one wind turbine.

28. A system according to claim 24, where the data filtering device (7) such as a firewall, said data filtering device (7) being part of the internal network (3,4), is positioned in the internal network (3,4) between the internal data network (3) and the internal servicing network (4), and where a control unit (5) is connected to the internal data network (3) at the same position of the internal network (3,4) as the data filtering device (7).

29. A system according to claim 28, where the data filtering device (7) being part of the internal network (3,4) and the control unit (5) both are connected along the internal data network (3) to a number of data storing and/or operating units (18,19) for operating at least one plant, possibly for operating only one plant.

30. A system according to claim 29, where the number of data operating units for operating the at least one plant comprises at least one of the following units of an energy producing unit, as example comprises at least one of the following units of a wind turbine: a plant control center, a plant data acquisition device.

31. A system according to claim 27, where a data filtering device (9) such as a firewall, said data filtering device being part of the external network (1,2), is positioned in the external network (1,2) between the external data network (1) and the external servicing network (2), and where the control unit (5) is connected to the external data network (1) at the same data network position as the data filtering device (9).

32. A system according to claim 31, where the data filtering device (9) of the external network (1,2) and the control unit (5) both are connected along the external data network (1) to a number data storing and/or operating units (12) for operating a plurality of plants.

33. A system according to claim 32, where the number of data operating units for operating the plurality of plants comprises at least one of the following units of an energy producing unit, as example comprises at least one of the following units of a wind turbine: a plant server, a local work station, a remote work station.

34. A system according to claim 23, where the external service network (2) and/or the internal service network (4) is provided with a number of service points (11,17) for accessing the external service network and/or the internal service network directly without having to access the external data network (1) and/or the internal data network (3).

35. A system according to claim 24, where an access point device (15) such as a wireless gateway, said access point being part of the internal network (3,4), is positioned between the internal data servicing network (4) and a dedicated network, and where the data filtering device (7) is connected to the internal data servicing network (4) at the same position of the internal network (3,4) as the access point device (15).

36. A system according to claim 35, where the dedicated network is a wireless network.

37. A system according to claim 35, where the dedicated network is a wired network.

38. A system according to claim 23,
both of said first data storage device (22) and said second data storage device (23) being accessible from an external data source,
said first data storage device (22) being connected to a first status controller (24), and said second data storage device (23) being connected to a second status controller (25),
said first data storage device (22) and said second data storage device (23) both having a write-protected state and a write-enabled state,
said first status controller (24) intended for controlling the transmission of data from the external data source to the first data storage device (22), and said second status controller (25) intended for controlling the transmission of data from the external data source to the second data storage device (23), and
a control unit (5) being intended for controlling the operating of the status controllers (24,25) by transmitting signals to either one or both of the status controllers (24,25), said signals from the control unit (5) intended for putting either one or both of the data storage devices (22,23) in one of two possible statuses,
either said signal being intended for telling one of the status controllers (24,25) to put the corresponding data storage device (22,23) in a write-enabled status for allowing data to be transmitted from the external data source to the corresponding data storage device (22,23),
or said signal being intended for telling one of the status controllers (24,25) to put the corresponding data storage device (22,23) in a write-protected status for denying data to be copied from the external data source to the corresponding data storage device (22,23).

39. A system according to claim 38, where the first status controller (24) and the second status controller (25) are integrated and constitutes one status controller common to the first data storage device (22) and the second data storage device (23), said one status controller being capable of individually both monitoring the status and controlling the status of the first data storage device and the second data storage device, respectively.

40. A system according to claim 38, where the first data storage device (22) and the second data storage device (23) are intended for acquiring data from an external data source of data for at least one plant, possibly for a plurality of plants within a collection of plants, and where the first data storage device (22) and the second data storage device (23) are intended for supplying data to at least one plant, possibly to only one plant.

41. A system according to claim 40, where the collection of plants is a plurality of energy producing units, where the plurality constitutes the collection and the individual energy producing units constitute individual plants, and where the first data storage device (22) and the second data storage device (23) constitutes data storage devices for at least one energy producing unit, possibly for only one energy producing unit.

42. A system according to claim 41, where the collection of plants is a park of wind turbines, where the park constitutes the collection and the individual wind turbines constitute individual plants, and where the first data storage device (22) and the second data storage device constitutes data storage devices for at least one wind turbine, possibly for only one wind turbine.

43. A method for operating a plant by a system according to claim 23, said method comprising the steps of:
dividing a data network into an external network (1,2) and an internal network (3,4),
dividing each of said external network (1,2) and said internal network (3,4) into a data network (1,3) for transmitting data within the plant, and a service network (2,4) for servicing the plant by receiving data from and/or transmitting data to the plant,
establishing a switching unit (6) for controlling the transmission of data from the external network (1,2) to the internal network (3,4), said switching unit (6) being provided at an interface between the external network (1,2) and the internal network (3,4), and
providing a data filtering device (7) for controlling the transmission of data from the internal data network (3) to the internal service network (4), said data filtering device (7) being provided in a parallel network connection at an interface between the switching unit (6) and the internal data network (3) and the internal service network (4), and
connecting said external network (1,2) to the internal network (3,4) along a control unit (5) and a switching unit (6) such as example a combination of a VLAN-aware switch and a firewall, possible a VLAN-aware firewall,
accessing said external network (1,2) from an external data source, and transmitting data from the external data source to the internal data network (3) along the external data network (1), along the data filtering device (7), along the control unit (5) and along the switching unit (6)
monitoring data being transmitted from the internal service network (4) to the internal data network (3) along said data filtering system (7), and
deciding whether the data being transmitted from the internal service network (4) to the internal data network (3) along the data filtering device (7) are data being valid or non-valid for operating the plant.

44. A method for operating a plant by a system according to claim 23, said method comprising the steps of
dividing a number of storage devices into at least a first data storage device (22) and a second data storage device (23),
connecting said first data storage device (22) to a first status controller (24), and connecting said second data storage device (23) to a second status controller (25),
applying to said first data storage device (22) and to said second data storage device (23) a write-protected state and a write-enabled state,
controlling transmission of data from the external data source to the first data storage device (22) by means of said first status controller (24),
controlling transmission of data from the external data source to the second data storage device (23) by means of said second status controller (25), and
controlling the operating of the status controllers (24,25) by transmitting signals from a control unit (5) to either one or both of the status controllers (24,25),
either said signals from the control unit (5) putting either one or both of the data storage devices (22,23) in a write-enabled status for allowing data to be transmitted from the external data source to the corresponding data storage device (22,23),
or said signals from the control unit (5) putting either one or both of the data storage devices (22,23) in a write-protected status for denying data to be transmitted from the external data source to the corresponding data storage device (22,23),
accessing the control unit (5) from the external data source, and transmitting data from the external data source to either one or both of the data storage (22,23) devices along the control unit (5) and the status controllers (24,25),
transmission to the data storage devices (22,23) being dependent on the status of the first data storage device (22) and the second data storage device (23).
